(19) United States
(12) Patent Application Publication
(10) Pub. No.: US 2001/0028195 A1
(43) Pub. Date: Oct. 11, 2001

(54) Vehicle braking system

(76) Inventor: Jingsheng Yu, Ludwigsburg (DE)

Correspondence Address: KENYON & KENYON, ONE BROADWAY, NEW YORK, NY, 10004, US

(21) Appl. No.: 09/747,255

(22) Filed: Dec. 22, 2000

(30) Foreign Application Priority Data
Dec. 30, 1999 (EP) 99 126 202.3

(51) Int. Cl. B60T 8/60

(52) U.S. Cl. 303/155

(57) ABSTRACT

A vehicle braking system for braking at least one wheel of a vehicle by producing a braking force that is adjustable by a braking pressure, the vehicle braking system having a controller for generating a manipulated variable for setting a brake valve by which the braking pressure is able to be adjusted, as well as a limiter for limiting the manipulated variable.

The invention relates to a vehicle braking system for braking at least one wheel of a vehicle by producing a braking force that is adjustable by a braking pressure, the vehicle braking system having a controller for generating a manipulated variable to set a brake valve by which the braking pressure is able to be adjusted. The invention also relates to a method for operating such a vehicle braking system.

Such a vehicle braking system is described, for example, in the German Patent 196 54 427 A1.

A vehicle braking system for braking at least one wheel of a vehicle by producing a braking force is also known from the German Patent 196 52 978 A1, the braking force being adjustable by a braking pressure which can be adjusted by setting a brake valve.

The object of the present invention is to improve the vehicle braking systems indicated above. It is desirable to adjust the braking pressure as quickly as possible and to reduce noise by a vehicle braking system, especially when using ABS (antilock braking system), TCS (traction control system) and ESP (electronic stability program). Details concerning ABS, TCS and ESP can be learned from the article “FDR—die Fahrdynamikregelung von Bosch” [ESP—Electronic Stability Program of Bosch] by A. van Zanten, R. Erhardt and G. Pfaff, ATZ Automobiltechnische Zeitschrift 96 (1994) 11 pages 674 through 689.

The objective is achieved by a vehicle braking system for braking at least one wheel of a vehicle by producing a braking force that is adjustable by a braking pressure, the vehicle braking system having a controller for generating a manipulated variable to set a brake valve by which the braking pressure is able to be adjusted, and the vehicle braking system having a limiter for limiting the manipulated variable. In this manner, it is possible to build up the desired braking pressure more quickly than is possible in a vehicle braking system according to DE 196 52 978 A1. In addition, the noise production in the vehicle braking system is reduced compared to the known vehicle braking systems. This is true in particular during the use of ABS, TCS and ESP.

In a particularly advantageous embodiment of the invention, the controller has an integral-action component (integrator), the controller advantageously being designed as a PID controller [proportional-plus-integral-plus-derivative controller]. The use of an integral-action component, e.g. a PID controller, leads to a particularly rapid build-up of the desired braking pressure. The cooperation of the limiter with a controller having an integral-action component results in an especially advantageous vehicle braking system. In addition, the noise production in the vehicle braking system is reduced compared to the known vehicle braking systems.

In an advantageous refinement of the invention, the limiter limits the manipulated variable to a range in which the correlation between the manipulated variable and the braking pressure adjusted by the brake valve is essentially linear. The regulation of the braking pressure is simplified in this manner.

According to a particularly advantageous development of the invention, the output of the limiter is coupled back in particular to the input of the controller. In this context, the feedback-coupling is advantageously effected with the aid of an inverse controller.

In an especially advantageous embodiment of the invention, the manipulated variable is a pulse-width-modulated (PWM) signal.

The present invention is used particularly advantageously in hydraulic vehicle braking systems as described, for example, in DE 196 52 978 A1, in DE 195 01 760 A1 or in the book “Automotive Handbook”, Bosch, 4th (English) edition, e.g. page 633.

Further advantages and particulars are disclosed in the following description of exemplary embodiments. In detail:

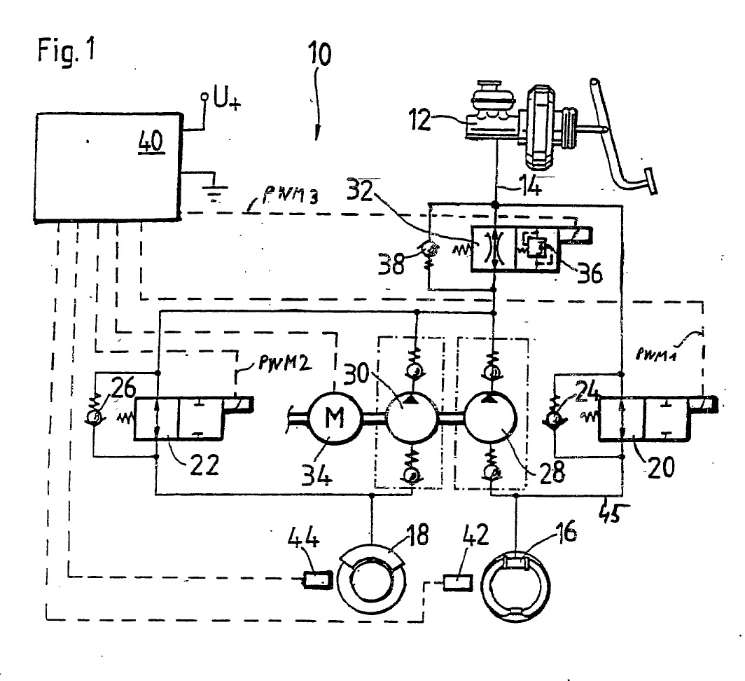

FIG. 1 shows a vehicle braking system;

FIG. 2 shows the use of a controller for producing a pulse-width-modulated signal;

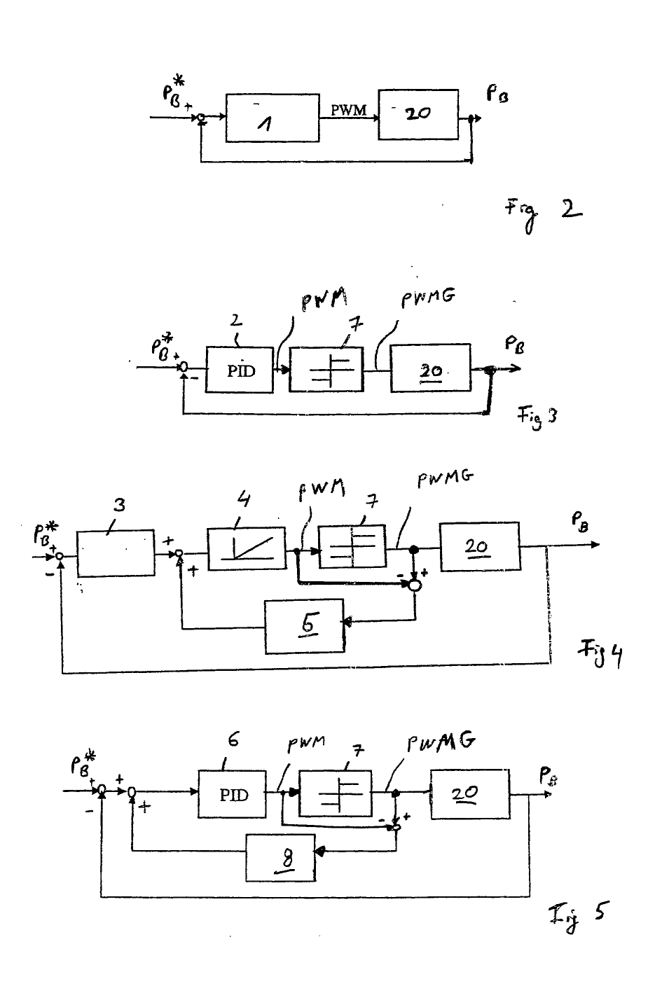

FIG. 3 shows the use of a limiter;

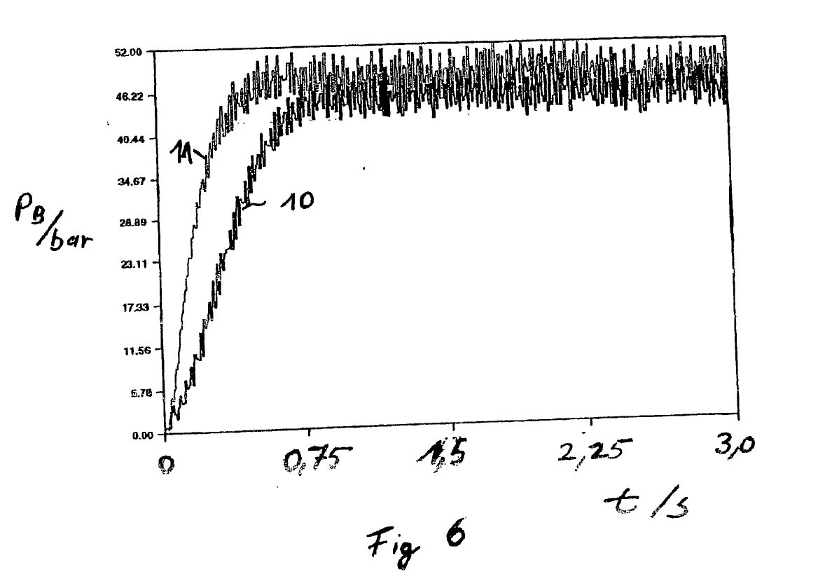

FIG. 4 shows a particularly advantageous exemplary embodiment;

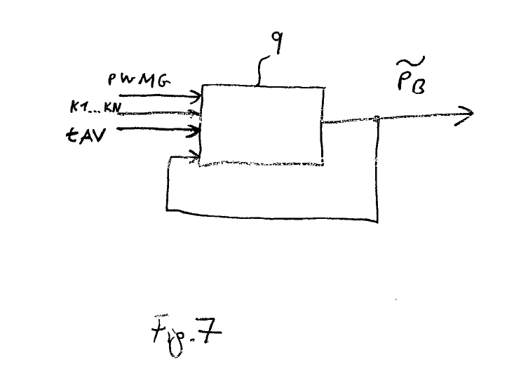

FIG. 5 shows an alternative, particularly advantageous exemplary embodiment;

FIG. 6 shows a characteristic curve of the braking pressure over time;

FIG. 7 shows a braking-pressure estimator for estimating the actual braking pressure;

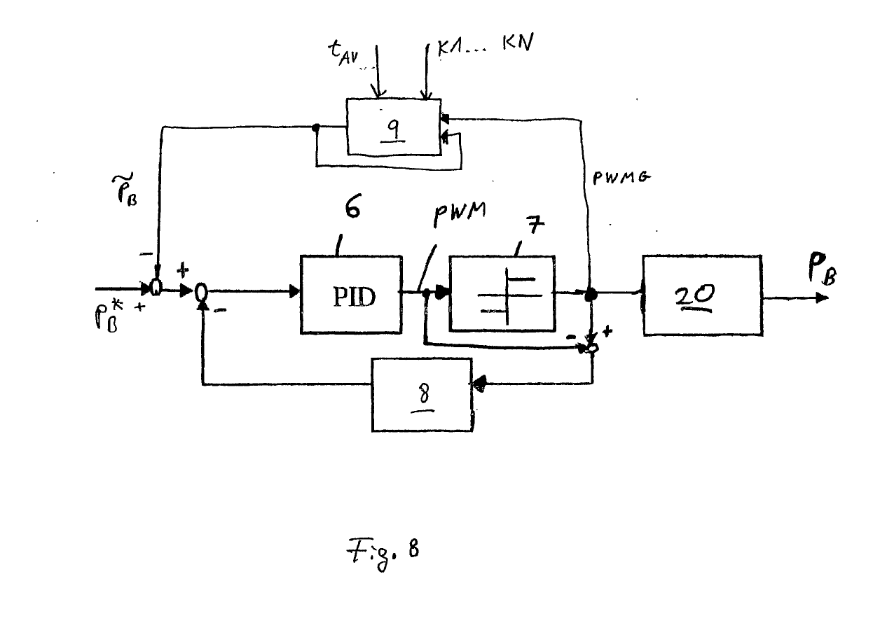

FIG. 8 shows the integration of a braking-pressure estimator.

FIG. 1 shows, by way of example, a brake circuit of a vehicle braking system, designated as a whole by 10, which is a vehicle braking system that is altered with respect to the vehicle braking system disclosed in the German Patent 196 52 973 A1. The brake circuit is connected to a master brake cylinder 12. Vehicle braking system 10 shown has an X-type braking apportioning, i.e. one front vehicle wheel and a diagonally opposite rear vehicle wheel are connected to one brake circuit. The left front wheel brake and the right rear wheel brake are connected to the brake circuit shown. The second brake circuit, to which the right front wheel brake and the left rear wheel brake are connected, is not shown. It is assumed that the front wheels are the driven vehicle wheels. Of course, the invention is also usable for differently designed brake circuits, as well as for vehicles in which the rear wheels are driven, or for vehicles driven by four-wheel drive.

The brake circuit of vehicle braking system 10 is connected by a brake line 14 to in each case a pressure chamber of master brake cylinder 12, the brake line branching and running to a wheel-brake cylinder 16 of a rear vehicle wheel which is not driven, and to a wheel-brake cylinder 18 of a driven front vehicle wheel. A wheel-brake valve 20, 22 is connected in advance of each wheel-brake cylinder 16, 18. Wheel-brake valves 20, 22 are solenoid valves which are open in their basic setting. Connected in parallel thereto is, in each case, a non-return valve 24, 26 which is able to be traversed by flow in the direction from wheel-brake cylinders 16, 18 to master brake cylinder 12. In the present exemplary embodiment, wheel-brake valves 20 and 22 are wheel-brake valves which are adjustable via a pulse-width-modulated (PWM) signal. The pulse-width-modulated signals for adjusting wheel-brake valves 20 and 22 are designated in FIG. 1 by reference symbols PWM1 and PWM2.

Wheel-brake cylinders 16, 18 are connected to intakes of two return pumps 28, 30 whose delivery sides are interconnected and which are connected via a switch-over valve 32 to master brake cylinder 12. Switch-over valve 32 is likewise a solenoid valve that is open in its basic setting. The two return pumps 28, 30 can be driven by a pump motor 34.

Integrated into switch-over valve 32 is a pressure-limiting valve 36 which is effective in the closed position of switch-over valve 32 and which limits the pressure difference between the wheel-brake-cylinder side and the master-brake-cylinder side to a predefined value. Integrated pressure-limiting valve 36 functions as a separate pressure-limiting valve parallel-connected to switch-over valve 32. A non-return valve 38, which is able to be traversed by flow in the direction from master brake cylinder 12 to wheel-brake cylinders 16, 18, is connected in parallel to switch-over valve 32.

Vehicle braking system 10 has an electronic control unit 40 which receives signals from wheel-speed sensors 42, 44, and which triggers pump motor 34, wheel-brake valves 20, 22 and switch-over valve 32. Electronic control unit 40 generates pulse-width-modulated signals PWM1 and PWM2, as well as PWM3 for triggering wheel-brake valves 20 and 22, as well as switch-over valve 32.

FIG. 2 shows the use of a controller 1 for generating a pulse-width-modulated signal PWM for controlling wheel-brake valve 20. In this context, pulse-width-modulated signal PWM in FIG. 2 corresponds to pulse-width-modulated signal PWM1 in FIG. 1. Wheel-brake valve 22 and switch-over valve 32 in FIG. 1 are driven in comparable manner. While according to the method known from DE 196 52 973 A1, a pulse-width-modulated signal is formed directly, i.e. without a controller, the present invention provides for using a controller 1 to generate pulse-width-modulated signal PWM. Controller 1 is advantageously implemented on control unit 40 in FIG. 1. Controller 1 forms pulse-width-modulated signal PWM from the difference between setpoint braking pressure p_{B}* in brake line 45 in FIG. 1, and the actual instantaneous braking pressure p_{B} in brake line 45 in FIG. 1.

In advantageous refinement (as in the exemplary embodiments according to FIGS. 3, 4 and 5 as well), provision is made not to measure actual braking pressure p_{B} in the brake line of the vehicle directly, but to estimate it with the aid of a model. To that end, the correlation between pulse-width-modulated signal PWM and braking pressure p_{B} is modeled through a PT2 system or a PT1 system. For reasons of clarity, this alternative, model-based determination of actual braking pressure p_{B} is not shown in the schematic basic circuit diagrams in FIGS. 1 through 5. The estimation of actual braking pressure p_{B} in brake line 45 of the vehicle by a model is explained more precisely in FIGS. 7 and 8.

FIG. 3 shows the use of a limiter 7. For that purpose, a limiter 7 is provided between a controller 2, which in the exemplary embodiment is designed as a PID controller, and wheel-brake valve 20. Limiter 7 limits pulse-width-modulated signal PWM output by controller 2, and outputs a limited pulse-width-modulated signal PWMG. Limited pulse-width-modulated signal PWMG in FIG. 3 corresponds to pulse-width-modulated signal PWM1 (or PWM2 and PWM3) in FIG. 1. Pulse-width-modulated signals PWM1, PWM2 and PWM3 in FIG. 1, PWM in FIG. 2 and PWMG in FIGS. 3, 4, 5 and 8 correspond to the manipulated variable in the claims.

FIG. 4 shows a particularly advantageous exemplary embodiment of the invention. In this case, in an especially advantageous refinement of the invention, the output of the limiter is coupled back to the input of a controller 4. This is achieved, in a particularly advantageous development, through feedback-coupling of the difference between output variable PWMG of limiter 7 and its input variable PWM. In addition, in an especially advantageous refinement, the back-coupling is effected via a differentiator 5. In the exemplary embodiment, controller 4 is designed as an integrator. A further controller 3 is also provided. Controllers 3 and 4 can also be interpreted as one controller, and controller 4 as the integral-action component (integrator) of this controller. Differentiator 5 is an inverse controller with respect to (I−) controller 4.

FIG. 5 shows an alternative exemplary embodiment to the exemplary embodiment from FIG. 4. In this case, the output of limiter 7 is coupled back to the input of a controller 6 with the aid of an inverse controller 8. Inverse controller 8 is an inverse controller with respect to controller 6, i.e., inverse controller 8 has a transfer function that is inverse to the transfer function of controller 6. The feedback-coupling is effected in a particularly advantageous development by back-coupling the difference between output variable PWMG of limiter 7 and its input variable PWM. A controller 3 is not provided. Controller 6 advantageously has an integral-action component (integrator) and is designed as a PID controller in the present exemplary embodiment.

FIG. 6 shows a characteristic curve of braking pressure p_{B} in bar over time t in seconds. FIG. 6 contrasts characteristic curve 10 of braking pressure p_{B} in a vehicle braking system according to DE 196 52 978 A1, and characteristic curve 11 of braking pressure p_{B} in a vehicle braking system according to FIG. 5 for a desired braking-pressure jump from 0 bar to 50 bar. As FIG. 6 shows, the target value of 50 bar is reached markedly faster by the vehicle braking system according to FIG. 5 than with the known vehicle braking system according to DE 196 52 978 A1. At the same time, the braking pressure of the vehicle braking system according to FIG. 5 does not overshoot. Thus, the desired braking pressure can be adjusted perceptibly more rapidly and, when the desired braking pressure changes quickly, can be adjusted more precisely by a vehicle braking system according to FIG. 5, particularly by the cooperation of the controller with integral-action component, the limiter and the inverse controller, than is possible with the known vehicle braking systems.

FIG. 7 shows a braking-pressure estimator 9 for estimating actual braking pressure p_{B} in a brake line of the vehicle. Braking-pressure estimator 9 determines an estimated value \tilde{p}_{B} of actual braking pressure p_{B}. In the present exemplary embodiment, braking-pressure estimator 9 has a PT2 system or a PT1 system, which is used to model the correlation between pulse-width-modulated signal PWM (for the use of braking-pressure estimator 9 in conjunction with the exemplary embodiment according to FIG. 3) or PWMG (for the use of braking-pressure estimator 9 in conjunction with the exemplary embodiments according to FIGS. 4 and 5), and braking pressure p_{B}. In addition to estimated value \tilde{p}_{B} of actual braking pressure p_{B} and pulse-width-modulated signal PWM (for the use of braking-pressure estimator 9 in conjunction with the exemplary embodiment according to FIG. 3) or PWMG (for the use of braking-pressure estimator 9 in conjunction with the exemplary embodiments according to FIGS. 4 and 5), the input variables of braking-pressure estimator 9 are parameters K1 through Kn of the model underlying braking-pressure estimator 9, thus of the PT2 system or the PT1 system in the present exemplary embodiment, and optionally the instantaneous position of an outlet valve. In the exemplary embodiment according to FIG. 1, no outlet valve is provided. However, if an outlet valve is provided, as is provided, for example, in the brake circuit described in the book “Automotive Handbook”, Bosch, 4th (English) edition, page 633 (see outlet valve), then its position is advantageously an input variable of braking-pressure estimator 9 and goes into the ascertainment of estimated value \tilde{p}_{B} of actual braking pressure p_{B}.

FIG. 8 shows the integration of a braking-pressure estimator 9 into the exemplary embodiment according to FIG. 5. In this case, not actual braking pressure p_{B}, but rather its estimated value \tilde{p}_{B} is the input variable into controller 6. The use of a braking-pressure estimator 9 in the exemplary embodiments according to FIGS. 3 and 4 is carried out in a corresponding manner.

1. A vehicle braking system (10) for braking at least one wheel of a vehicle by producing a braking force that is adjustable by a braking pressure (p_{B}), the vehicle braking system (10) having a controller (2, 4, 6) for generating a manipulated variable (PWM, PWMG, PWM1, PWM2, PWM3) for setting a brake valve (20, 22) by which the braking pressure (p_{B}) is able to be adjusted,
characterized in that the vehicle braking system (10) has a limiter (7) for limiting the manipulated variable (PWM, PWMG, PWM1, PWM2, PWM3).

2. The vehicle braking system (10) as recited in claim 1,
characterized in that the controller (2, 4, 6) forms the manipulated variable (PWM, PWMG, PWM1, PWM2, PWM3), in an adjusting manner, as a function of the difference between the desired setpoint braking pressure (p_{B}) and the actual braking pressure (p_{B}).

3. The vehicle braking system (10) as recited in claim 1 or 2,
characterized in that the controller (2, 4, 6) has an integrator.

4. The vehicle braking system (10) as recited in claim 3,
characterized in that the controller (2, 6) is a PID controller.

5. The vehicle braking system (10) as recited in one of the preceding claims,
characterized in that the limiter (7) limits the manipulated variable (PWM, PWMG, PWM1, PWM2, PWM3) to a range in which the correlation between the manipulated variable (PWM, PWMG, PWM1, PWM2, PWM3) and the braking pressure (p_{B}) adjusted by the brake valve (20, 22) is essentially linear.

6. The vehicle braking system (10) as recited in one of the preceding claims,
characterized in that the manipulated variable is a pulse-width-modulated signal (PWM, PWMG, PWM1, PWM2, PWM3).

7. The vehicle braking system (10) as recited in claim 6,
characterized in that the limiter (7) limits the pulse-width-modulated signal (PWM, PWMG, PWM1, PWM2, PWM3) to a range in which the correlation between the current of the pulse-width-modulated signal (PWM, PWMG, PWM1, PWM2, PWM3) and the braking pressure (p_{B}) adjusted by the brake valve (20, 22) is essentially linear.

8. The vehicle braking system (10) as recited in one of the preceding claims,
characterized in that the output of the limiter (7) is back-coupled.

9. The vehicle braking system (10) as recited in claim 8,
characterized in that the output of the limiter (7) is coupled back to the input of the controller (4, 6).

10. The vehicle braking system (10) as recited in claim 9,
characterized in that the output of the limiter (7) is coupled back to the input of the controller (4, 6) via an inverse controller (5, 8).

11. A method for operating a vehicle braking system (10) according to one of the preceding claims for braking at least one wheel of a vehicle by producing a braking force which is adjusted by a braking pressure (p_{B}), the braking pressure (p_{B}) being set with the aid of a manipulated variable (PWM, PWMG, PWM1, PWM2, PWM3),
characterized in that the manipulated variable (PWM, PWMG, PWM1, PWM2, PWM3) is limited.
